(19) United States
(12) Patent Application Publication
(10) Pub. No.: US 2022/0219183 A1
(43) Pub. Date: Jul. 14, 2022

(54) WATER STREAM STOP VALVE FOR SPRINKLER

(71) Applicant: PLASTICO CORPORATION, TAIPEI CITY (TW)

(72) Inventor: TSUNG MIN CHOU, TAIPEI CITY (TW)

(21) Appl. No.: 17/145,685

(22) Filed: Jan. 11, 2021

(51) Int. Cl. B05B 12/08

(52) U.S. Cl. CPC B05B 12/087

(57) ABSTRACT

A water stream stop valve for sprinkler, comprising: a tube body; an annular cover; multiple securing units; and a drainage body having a hole at the center is arranged above the tube body by multiple support plates; whereby water stream stop valve is applied in a pop-up sprinkler, wherein the pop-up sprinkler includes: a main body; an expansion pipe, and having a stop member arranged at top internal diameter thereof; a spray head; and the water stream stop valve is arranged inside the expansion pipe and below the spray head; When the spray head falls off spray head, the water stream stop valve will be pushed up to the top of the expansion pipe and stop at the stop member for avoiding the overflow of water, maintaining the spraying at the original area, and delivering a service indication stream.

### BACKGROUND OF THE INVENTION

### 1. Field of the Invention

The invention relates to a water stream stop valve for sprinkler, especially to one that can avoid the overflow of water, maintain the spraying at the original area, and deliver a service indication stream, when the spray head fell off.

### 2. Description of the Related Art

Referring to FIGS. 1-3, the main body 11 of the prior art pop-up sprinkler 10 is buried underground, the main body 11 having an expansion pipe 12 arranged inside and enable to pop out the ground and watering the ground by the spray head 13, so this type pop-up sprinkler 10 can make the installation site tidier; however, once the spray head 13 of the pop-up sprinkler 10 fell off, the water stream will leak from the top of the expansion pipe 12, as FIG. 4 showing, and if doesn't notice the fell off of the spray head 13 will cause the flooding and the low water pressure of other pop-up sprinkler 10.

### SUMMARY OF THE INVENTION

It is a primary objective of the present invention to provide a water stream stop valve for sprinkler that cam solve the water leakage problem while the sprinkler fell off.

It is another objective of the present invention to provide a water stream stop valve for sprinkler that maintain the spraying at the original area, and deliver a service indication stream

In order to achieve the above objectives, the present invention includes: a tube body; an annular cover arranged on the outer periphery of the tube body; multiple securing units arranged vertically on the outer periphery of the tube body; a drainage body having a hole at the center is arranged above the tube body by multiple support plates, and the aperture of the hole is smaller than the top internal diameter of the tube body;

Moreover, the internal diameter of the tube body gradually shrinks from bottom to top, and the bottom surface of the drainage body is upwards from the inside to the outside.

Whereby water stream stop valve is applied in a pop-up sprinkler, wherein the pop-up sprinkler includes: a main body; an expansion pipe arranged on the main body, and having a stop member arranged at top internal diameter thereof; a spray head arranged at the top edge of the expansion pipe; and the water stream stop valve is arranged inside the expansion pipe and below the spray head; When the spray head fell off, due to the water pressure, the water stream stop valve will be pushed up to the top of the expansion pipe and stop at the stop member for avoiding the overflow of water, maintaining the spraying at the original area, and delivering a service indication stream.

### BRIEF DESCRIPTION OF THE DRAWINGS

FIG. 1 is a schematic diagram illustrating a pop-up sprinkler according to the prior art, while the expansion pipe is hidden;

FIG. 2 is a schematic diagram illustrating the pop-up sprinkler according to the prior art, while the expansion pipe is pop-up;

FIG. 3 is a schematic diagram illustrating the structure of a pop-up sprinkler according to the prior art;

FIG. 4 is a schematic diagram illustrating the structure of a pop-up sprinkler according to the prior art, while the spray head fell off;

FIG. 5A is a perspective views of the water stream stop valve of the present invention;

FIG. 5B is a sectional view along line 5B-5B in FIG. 5A;

FIG. 6 is a schematic diagram illustrating the structure of a water stream stop valve of the present invention;

FIG. 7 is a schematic diagram illustrating the application of a water stream stop valve of the present invention;

FIG. 8 is a schematic diagram illustrating the spraying of a water stream stop valve of the present invention.

### DETAILED DESCRIPTION OF THE PREFERRED EMBODIMENT

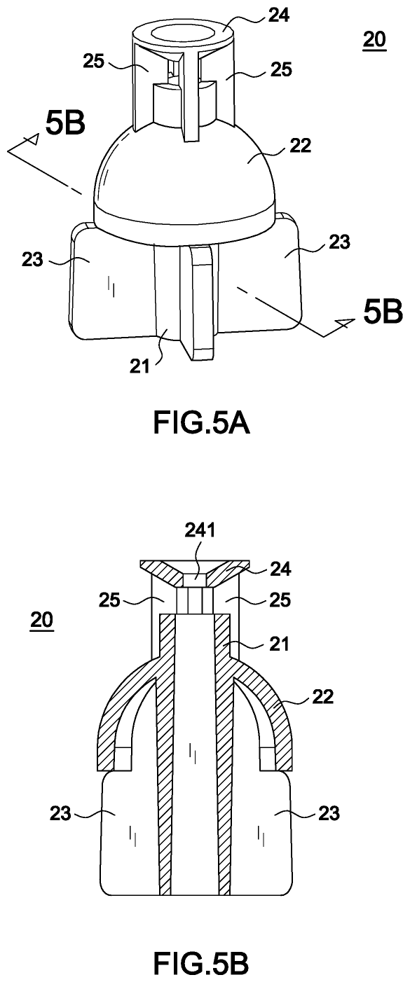

Referring to FIG. 5A and FIG. 5B, a water stream stop valve 20 of the present invention includes a tube body 21 gradually shrinks from bottom to top, an annular cover 22 arranged on the outer periphery of the tube body 21; and multiple securing units arranged vertically on the outer periphery of the tube body 21, and the bottom surface of the drainage body 24 is upwards from the inside to the outside.

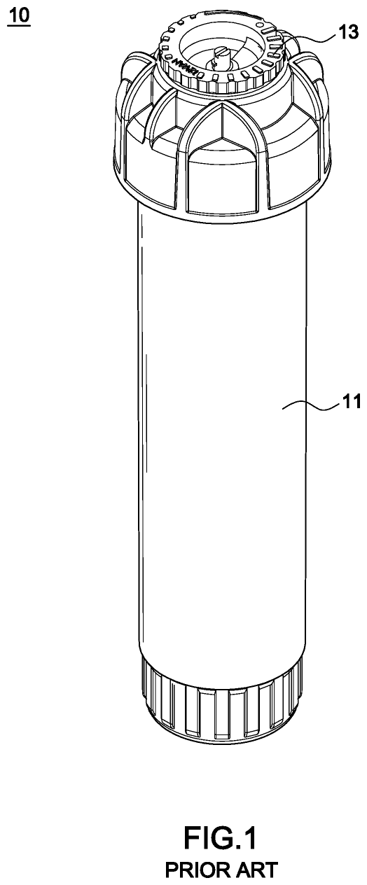

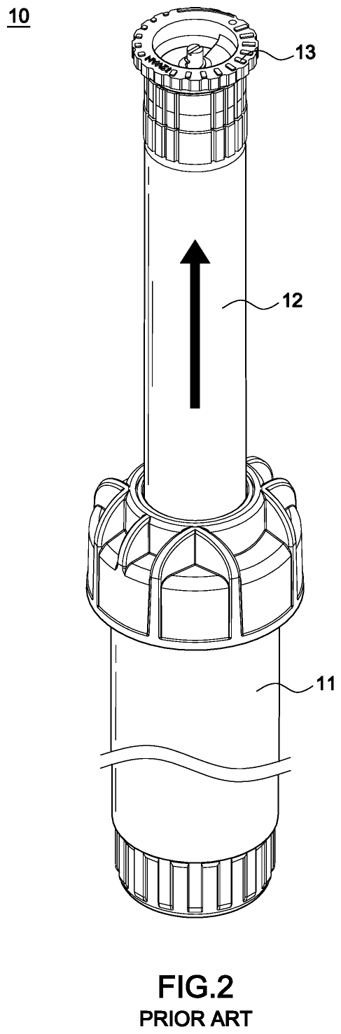

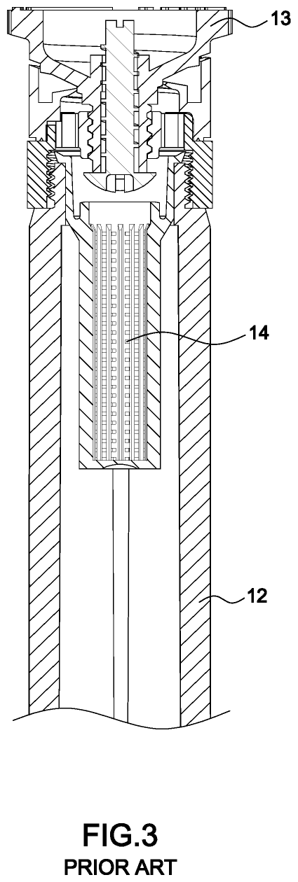

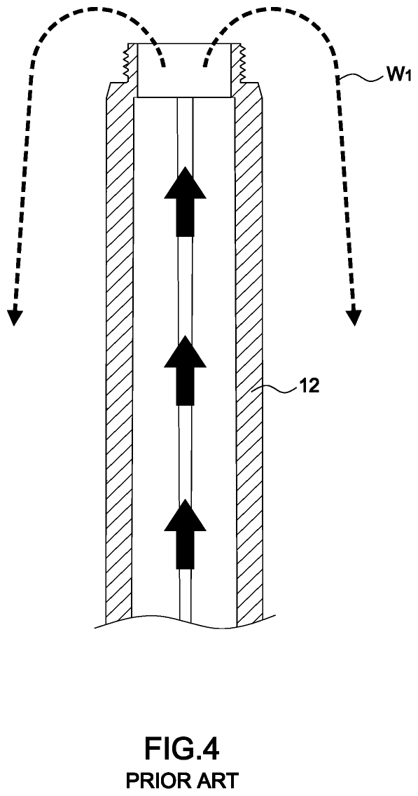

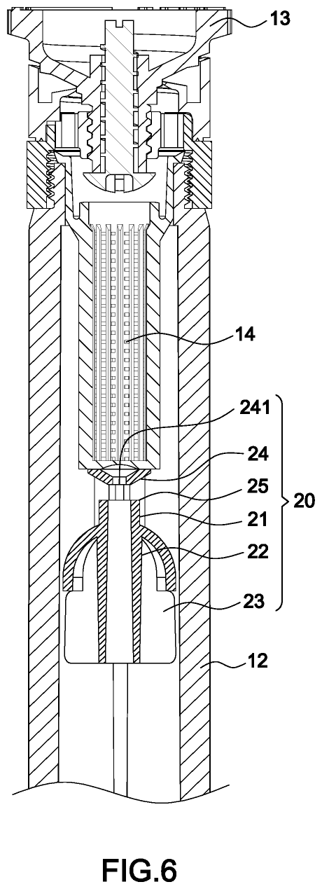

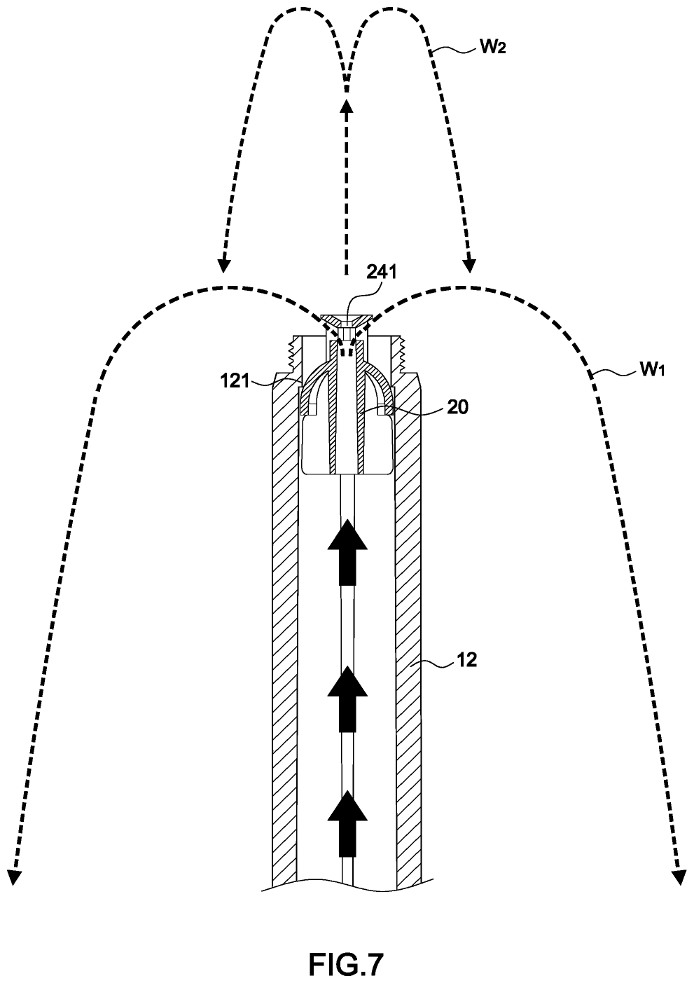

With the feature disclosed above, referring to FIG. 1, FIG. 2, FIG. 6, and FIG. 7, when water stream stop valve 20 of the present invention is applied on a pop-up sprinkler 10, wherein the pop-up sprinkler 10 includes: a main body 11; an expansion pipe 12 arranged on the main body 11, and having a stop member 121 arranged at top internal diameter thereof; a spray head 13 arranged at the top edge of the expansion pipe 12; and the water stream stop valve 20 is arranged inside the expansion pipe 12 and below the spray head 13; When the spray head 13 fell off, due to the water pressure, the water stream stop valve 20 will be pushed up to the top of the expansion pipe 12 and stop at the stop member 121 for avoiding the overflow of water, maintaining the spraying W1 at the original area, and delivering a service indication stream W2.

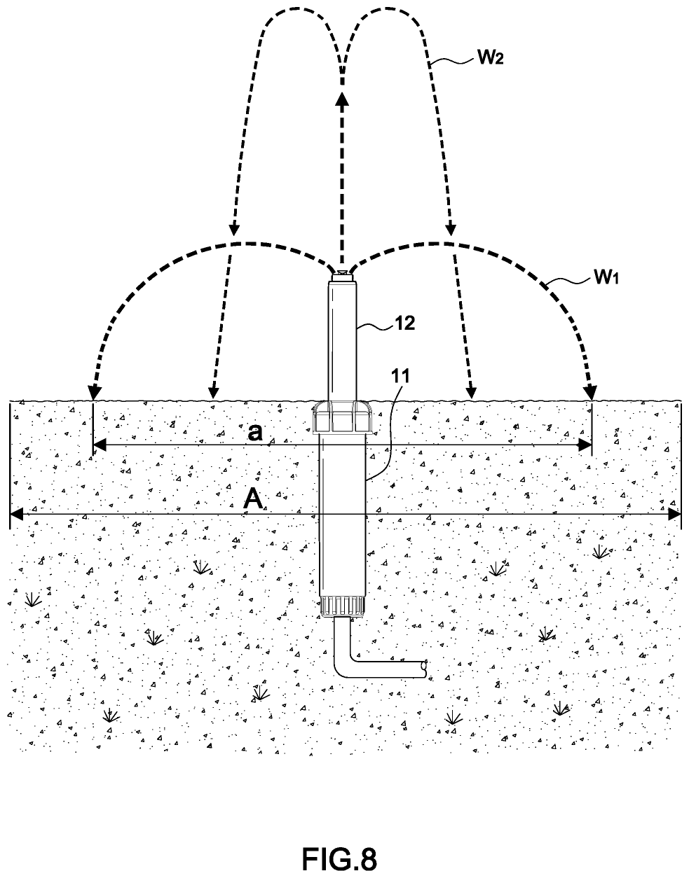

Also, referring to FIG. 8, using the bottom surface of the drainage body 24 to guide the water spraying at the area (a) to be closed to the original spraying area (A) with the spray head 13, and the hole 241 deliver a service indication stream W2 for notifying the user the function error of the pop-up sprinkler 10, and maintaining the spraying W1 at the original area.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A water stream stop valve for sprinkler, comprising:
a tube body;
an annular cover arranged on the outer periphery of the tube body;
multiple securing units arranged vertically on the outer periphery of the tube body; and
a drainage body having a hole at the center is arranged above the tube body by multiple support plates, and the aperture of the hole is smaller than the top internal diameter of the tube body;
whereby water stream stop valve is applied in a pop-up sprinkler, wherein the pop-up sprinkler includes: a main body; an expansion pipe arranged on the main body, and having a stop member arranged at top internal diameter thereof; a spray head arranged at the top edge of the expansion pipe; and the water stream stop valve is arranged inside the expansion pipe and below the spray head; When the spray head falls off spray head, due to the water pressure, the water stream stop valve will be pushed up to the top of the expansion pipe and stop at the stop member for avoiding the overflow of water, maintaining the spraying at the original area, and delivering a service indication stream.

2. The water stream stop valve for sprinkler as claimed in claim 1, wherein the internal diameter of the tube body gradually shrinks from bottom to top.

3. The water stream stop valve for sprinkler as claimed in claim 1, wherein the bottom surface of the drainage body is upwards from the inside to the outside.
